(19) United States
(12) Patent Application Publication
(10) Pub. No.: US 2018/0340901 A1
(43) Pub. Date: Nov. 29, 2018

(54) GAS SENSOR PLATFORM AND THE METHOD OF MAKING THE SAME

(71) Applicant: INVENSENSE, INC., San Jose, CA (US)

(72) Inventors: Fang Liu, San Jose, CA (US); Martin Lim, San Mateo, CA (US); Baris Cagdaser, Sunnyvale, CA (US)

(21) Appl. No.: 16/038,499

(22) Filed: Jul. 18, 2018

Related U.S. Application Data
(62) Division of application No. 14/849,551, filed on Sep. 9, 2015, now abandoned.

(51) Int. Cl. G01N 27/04; G01N 27/414; G01K 7/16; G01N 27/12

(52) U.S. Cl. CPC G01N 27/046; G01N 27/4148; G01N 27/128; G01K 7/16

(57) ABSTRACT

The present invention relates to low power, low cost, and compact gas sensors and methods for making the same. In one embodiment, the gas sensor includes a heating element embedded in a suspended structure overlying a substrate. The heating element is configured to generate an amount of heat to bring the chemical sensing element to an operating temperature. The chemical sensing element is thermally coupled to the heating element. The chemical sensing element is also exposed to an environment that contains the gas to be measured. In one embodiment, the chemical sensing element comprises a metal oxide compound having an electrical resistance based on the concentration of a gas in the environment and the operating temperature of the chemical sensing element. In this embodiment, the operating temperature of the chemical sensing element is greater than room temperature and determined by the amount of heat generated by the heating element.

### RELATED APPLICATION

This is a Divisional patent application that claims priority to U.S. patent application Ser. No. 14/849,551, filed on Sep. 9, 2015 and entitled “GAS SENSOR PLATFORM AND THE METHOD OF MAKING THE SAME,” the entirety of which is incorporated by reference herein.

### BACKGROUND

Certain gas sensors rely on physical or chemical changes in a chemical sensing material while in the presence of a gas to determine the concentration of that gas in the surrounding environment. Further, certain chemical sensing materials preferentially operate at a temperature above normal ambient or room temperatures. However, incorporating a heater in a chemical sensing device can cause damage to other integrated components, increase cost of the device, and increase the power consumption of the device.

### SUMMARY

The following presents a simplified summary of one or more of the embodiments of the present invention in order to provide a basic understanding the embodiments. This summary is not an extensive overview of the embodiments described herein. It is intended to neither identify key or critical elements of the embodiments nor delineate any scope of embodiments or the claims. This Summary's sole purpose is to present some concepts of the embodiments in a simplified form as a prelude to the more detailed description that is presented later. It will also be appreciated that the detailed description may include additional or alternative embodiments beyond those described in the Summary section.

The present invention recognizes and addresses, in at least certain embodiments, the issue of providing a low power, low cost, and compact gas sensor. The disclosed gas sensor can be fabricated using conventional CMOS processing technology resulting in a low power sensor that can be produced at lower costs. In one example, one or more chemical sensing material is deposited on electrodes that allow measurement of changes in the chemical sensing material due to changes in concentration of certain chemicals in the ambient. The electrodes and chemical sensing material are formed on a dielectric member that mechanically and thermally couples the electrodes and chemical sensing material to a deposited heating layer and thermal sensing layer. The above layers are thermally isolated from the bulk of the chip by a thermal isolation cavity.

The resulting gas sensor has less light sensitivity due to substrate isolation, has heat feedback control to improve sensor stability, and has an integrated heating element to improve response and/or recovery time. This disclosure further provides a flexible platform for fabricating the gas sensor that can be easily modified and adapted to specific sensor needs. For example, the disclosed platform supports fabrication of gas sensor using multiple sensing materials. Further, the platform allows an integrated circuit (such as an application specific integrated circuit or ASIC) for controlling the gas sensor to be integrated with the gas sensor on one chip, thereby providing a more-compact complete gas sensor solution.

Other embodiments and various examples, scenarios and implementations are described in more detail below. The following description and the drawings set forth certain illustrative embodiments of the specification. These embodiments are indicative, however, of but a few of the various ways in which the principles of the specification may be employed. Other advantages and novel features of the embodiments described will become apparent from the following detailed description of the specification when considered in conjunction with the drawings.

### BRIEF DESCRIPTION OF THE DRAWINGS

FIG. 1 illustrates a cross sectional side view of an example of a gas sensor in accordance with one or more embodiments of the disclosure.

FIG. 2 illustrates a top down view of a portion of the example gas sensor of FIG. 1.

FIG. 3 illustrates a method for fabricating a structure of a gas sensor in accordance with one or more embodiments of the disclosure.

FIGS. 4-8 illustrate various stages of an example method for fabricating a gas sensor in accordance with one or more embodiments of the disclosure.

FIG. 9 illustrates a methods for fabricating a structure of a gas sensor in accordance with one or more embodiments of the disclosure.

FIGS. 10-14 illustrate various stages of an example method for fabricating a gas sensor in accordance with one or more embodiments of the disclosure.

FIG. 15 illustrates a cross sectional side view of an example of a gas sensor in accordance with one or more embodiments of the disclosure.

FIG. 16 illustrates a cross sectional side view of an example of a gas sensor in accordance with one or more embodiments of the disclosure.

### DETAILED DESCRIPTION

The disclosure recognizes and addresses, in at least certain embodiments, the issue of providing a low power, low cost, and compact gas sensor. The disclosed gas sensor can be fabricated using conventional CMOS processing technology resulting in a low power sensor that can be produced at lower costs. In one example, one or more chemical sensing material is deposited on electrodes that allow measurement of changes in the chemical sensing material due to changes in concentration of certain chemicals in the ambient. The electrodes and chemical sensing material are formed on a dielectric member that mechanically and thermally couples the electrodes and chemical sensing material to a deposited heating layer and thermal sensing layer. The above layers are thermally isolated from the bulk of the chip by a thermal isolation cavity.

The resulting gas sensor has less light sensitivity due to substrate isolation, has heat feedback control to improve sensor stability, and has an integrated heating element to improve response and/or recovery time. This disclosure further provides a flexible platform for fabricating the gas sensor that can be easily modified and adapted to specific sensor needs. For example, the disclosed platform supports fabrication of gas sensor using multiple sensing materials. Further, the platform allows an integrated circuit (an ASIC for example) for controlling the gas sensor to be integrated with the gas sensor on one chip, thereby providing a more-compact complete gas sensor solution.

When compared to conventional technologies, the gas sensors of the disclosure can be achieved with a simplified, more flexible design that can reduce complexity of fabrication process flow, with associated lower costs of fabrication. Such a design permits multiple sensor configurations and accords processing flexibility in accordance with aspects of this disclosure. Gas sensors of this disclosure also can provide greater performance (e.g., higher sensitivity and/or fidelity) when compared to conventional gas sensors.

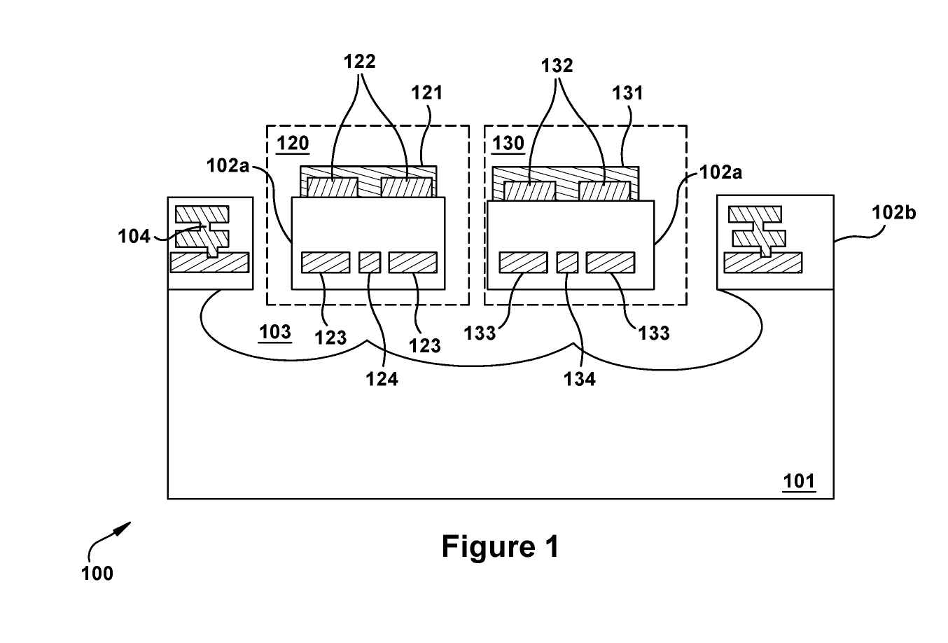

With reference to the drawings, FIG. 1 illustrates side cross section view of an example of a gas sensor 100 in accordance with one or more embodiments of the disclosure. As illustrated, the gas sensor includes a substrate 101 on which the other elements are built. On the substrate 101, a dielectric layer 102 is deposited or formed. For illustration, the gas sensor 100 includes two types of sensor pixels, 120 and 130. The gas sensor 100 can be built with many pixels of one or more types of pixel. Having multiple types of sensor pixel allows the sensor to use various receptors that are sensitive to different types and concentrations of gases and thereby detect and distinguish between different gases and concentrations. Accordingly, with the present sensor it is possible to detect numerous different gases at various concentrations.

Pixel 120 includes a layer of chemical sensing materials 121, and pixel 130 includes a layer of chemical sensing material 131. The chemical sensing materials may be metal oxides including oxides of chromium, manganese, nickel, copper, tin, indium, tungsten, titanium, vanadium, iron, germanium, niobium, molybdenum, tantalum, lanthanum, cerium, and neodymium. Alternatively, the chemical sensing materials may be composite oxides including binary, ternary, quaternary and complex metal oxides. Metal oxide gas sensors are low cost and have flexibility in production, are simple to use, and have a large number of detectable gases/possible application fields. Accordingly, the metal oxide used in a specific application may be selected for sensitivities to certain chemicals. Metal oxides also function well as a chemical sensing material because they can be used to detect chemical changes through conductivity change as well as by measuring the change of capacitance, work function, mass, optical characteristics or reaction energy.

Adjacent to the chemical sensing materials 121, 131, there are contact electrodes 122, 132. The contact electrodes are electrically connected to the chemical sensing materials 121, 131 and are used to detect changes in the chemical sensing materials 121, 131 as the concentration of the target gas changes. The contact electrodes 122, 132 can be made of conductive materials including noble metals, titanium nitride, polysilicon, and/or tungsten.

The gas sensor pixels 121, 131 also includes a heating element 123, 133. The heating element can be formed through standard CMOS processes to form a resistive heating element, including by using polysilicon, tungsten, titanium nitride, or silicon carbide. In on embodiment of the gas sensor, the heating element 123, 133 is formed to maximize the surface area in the device to improve heating efficiency. The heating element 123, 133 is beneficial to the gas sensing pixel because the chemical sensing materials 123, 133 may only be sufficiently sensitive at a high temperature. For example, the operating temperature of some chemical sensing material is ideally above 100 degrees Celsius to achieve sensitivity sufficient for robust measurement. Moreover, different chemical sensing materials may have different activation temperatures, and the heating element can be used to optimize conditions for a given gas. The gas sensor pixels 120, 130 also include a temperature sensor 124, 134 to measure the temperature of the pixels 120, 130 and provide feedback for temperature control. The temperature sensor 124, 134 may be formed from the same material and at the same time as the heating element 123, 133, thereby reducing processing time and complexity. The temperature sensor 124, 134 may be formed from a material whose resistance changes as a function of temperature. For example, the following equation demonstrates a relationship between resistance and temperature change for a conductive material. In the equation below, R_{h/t}(T) is the resistance of the material at the current temperature T. R(T₀) is the resistance of the material at an initial temperature T₀ and α is the temperature coefficient of resistivity of the material.

R_{h/t}(T)=R(T₀)[1+α(T−T₀)]

As shown in FIG. 1, the dielectric layer 102 is adjacent to the chemical sensing material 121, 131, contact electrodes 122, 132, heating element 123, 133, and temperature sensor 124, 134. The dielectric layer 102 provides thermal coupling between the heating element 123, 133 and the chemical sensing material 121, 131 so that the heat provided by the heating element 123, 133 is conducted to the chemical sensing material 121, 131. Accordingly, the dielectric is preferably a low k dielectric material with certain thermal conductivity. The dielectric layer 102 also provides mechanical support for the elements of the gas sensor pixel 120, 130. At locations not shown in FIG. 1, the dielectric layer 102b from the bulk of the chip is connected to the dielectric layer 102a in the pixels 120, 130. These connections provide mechanical support and allows for electrical connections to the contact electrodes 122, 132, heating element 123, 133, and temperature sensor 124, 134. A portion of the substrate 101 underneath the pixels 120, 130 is etched or otherwise removed to create a thermal isolation cavity 103 that thermally isolates the pixels 120, 130 from the bulk of the substrate. The thermal isolation cavity 103 allows integration of the chemical sensor with other devices (ASIC 104 for example) on the same chip. The thermal isolation cavity 103 protects other devices on the chip from heat produced by the heating element 123, 133. This protects the other devices from possible thermal damage and reduces the power consumption required to heat the pixel 120, 130 to the operating temperature since less heat is dissipated from the pixel 120, 130 to the bulk substrate. The chemical sensing materials 121, 131 may have an operating or activation temperature at which, or above which, the sensitivity of the chemical sensing materials 121, 131 reaches a desired threshold.

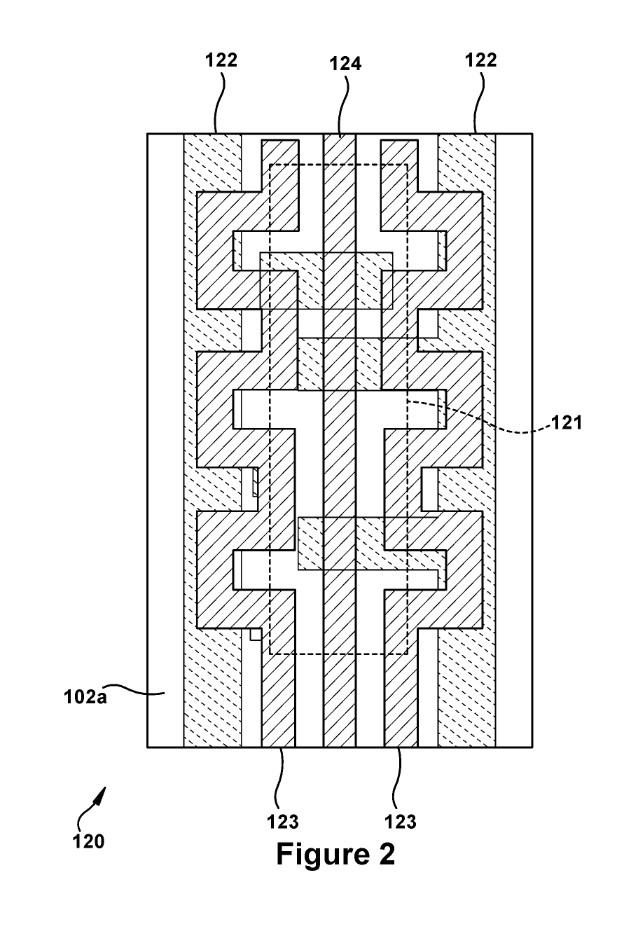

FIG. 2 is a top-down view of the pixel 120 of the gas sensor 100 in FIG. 1. The pixel 120 includes the layer of chemical sensing materials 121. Adjacent to the chemical sensing material 121 there are contact electrodes 122. The contact electrodes are electrically connected to the chemical sensing material 121 and are used to detect changes in the chemical sensing material 121 as the concentration of the target gas changes. The gas sensor pixel 121 also includes a heating element 123. The heating element can be formed through standard CMOS processes to for a resistive heating element, including using polysilicon, tungsten, titanium nitride, or silicon carbide. In on embodiment of the gas sensor, the heating element is formed to maximize the surface area per unit of area of the device to improve heating efficiency. As shown in FIG. 2, the heating element 123 may have a serpentine structure to maximize the surface area and heating efficiency of the heating element 123.

The gas sensor pixel 121 also include a temperature sensor 124 to measure the temperature of the pixels 121 and provide feedback for temperature control. In the pixel 120, the dielectric layer 102a is adjacent to the chemical sensing material 121 contact electrodes 122 heating element 123 and temperature sensor 124. The dielectric layer 102b from the bulk of the chip is connected to the dielectric layer 102a in the pixels 120, 130 to provide mechanical support and allowing electrical connections of contact electrodes 122, heating elements 123 and temperature sensor 124 to ASIC.

As described above, in one embodiment, the gas sensor includes a heating element 123, 133 embedded in a suspended structure overlying a doped semiconductor substrate 101. The heating element 123, 133 is configured to generate an amount of heat to bring the chemical sensing element 122, 132 to an operating temperature. The chemical sensing element 122, 132 is thermally coupled to the heating element 123, 133. The chemical sensing element 122, 132 is also exposed to an environment that contains the gas to be measured. In one embodiment, the chemical sensing element 122, 132 comprises a metal oxide compound having an electrical resistance based on the concentration of a gas in the environment and the operating temperature of the chemical sensing element 122, 132. In this embodiment, the operating temperature of the chemical sensing element 122, 132 is greater than room temperature and determined by the amount of heat generated by the heating element 123, 133. In, one example the operating temperature of the chemical sensing element 122, 132 is 100 degrees Celsius. The gas sensor also includes a temperature sensor 124, 134 configured to supply an electric signal in response to the temperature of the chemical sensing element 122, 132. The temperature sensor 124, 134 is thermally coupled to the chemical sensing element 122, 132 so that the temperature sensor 124, 134 can determine the temperature at the chemical sensing element 122, 132. In one example, the temperature sensor 124, 134 comprises any one of polycrystalline silicon, tungsten, titanium nitride.

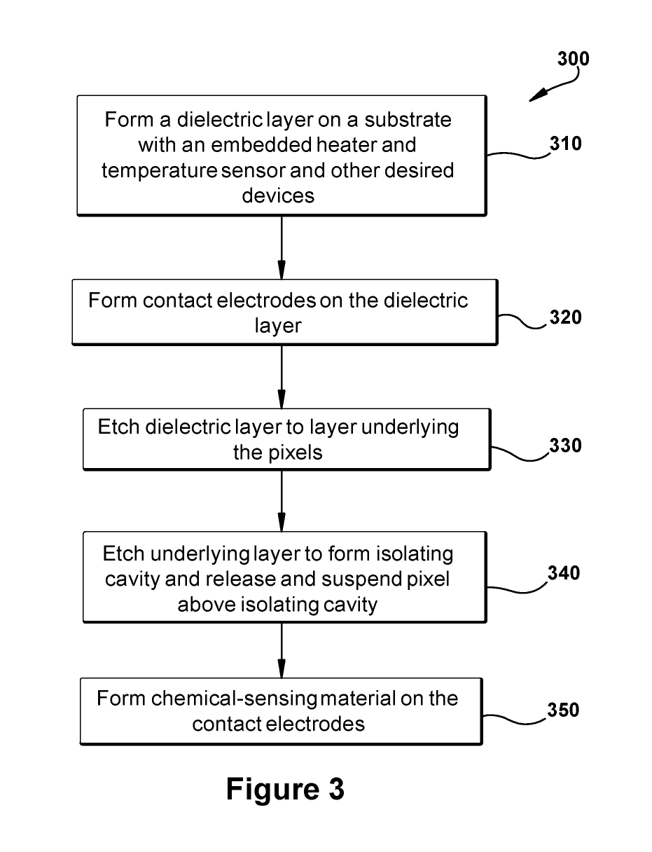

FIG. 3 presents a flowchart of an example method 300 for fabricating a gas sensor in accordance with one or more embodiments of the disclosure. At block 310, a dielectric layer is formed on a substrate. The substrate can include, for example, a semiconductor layer (e.g., a silicon slab or a silicon-on-insulator layer). A heating element is embedded in the dielectric layer. A temperature sensor is also embedded in the dielectric layer. The temperature sensor is used to measure the temperature of the pixel and provide feedback for temperature control. The heating element can be formed through standard CMOS processes to for a resistive heating element, including using polysilicon, tungsten, titanium nitride, or silicon carbide. The temperature sensor may be formed from the same material and at the same time as the heating element, thereby reducing processing time and complexity. The temperature sensor is made from a material whose physical properties—such as resistance—change as a function of temperature. Other devices required by the design may also be included. For example, one or more ASIC device for controlling the heating (and thereby the operating temperature), evaluating the pixel temperature, and/or determining the gas concentration from the signals received from the pixels may be included. The ASIC may be configured measure the electrical resistance of the chemical sensing element to determine the gas concentration in the environment.

At block 320 contact electrodes are formed on the dielectric layer. The contact electrodes are electrically connected to the chemical sensing material and are used to detect changes in the chemical sensing material as the concentration of the target gas changes. The contact electrodes can be made of conductive materials including noble metals or titanium nitride. The contact electrodes may be formed using conventional CMOS processing techniques including by sputter deposition followed by photolithographic patterning and removal of the unwanted deposited material. At block 330, the dielectric layer is etched to the substrate or layer underlying the pixels. This etch may be done by wet etching or dry etching and it can be isotropic or anisotropic. In a preferred method, the etching is an anisotropic etch such as deep reactive ion etching.

Next, at block 340, the substrate or area underlying the pixels is etched to release the pixels from the bulk of the substrate or underlying layer. This etch may be done by wet etching or dry etching and it can be isotropic or anisotropic. In a preferred method, the etching is an isotropic gas or plasma etch such as a xenon difluoride etch or a sulfur hexafluoride etch. In this etch step, a portion of the substrate or layer underneath the pixels is etched or otherwise removed to create a thermal isolation cavity that thermally isolates the pixels from the bulk of the substrate. The thermal isolation cavity allows integration of the chemical sensor with other devices (an ASIC for example) on the same chip. The thermal isolation cavity protects other devices on the chip from heat produced by the heating element and reduces the power consumption required to heat the pixel to the operating temperature since less heat is dissipated from the pixel to the bulk substrate. The dielectric layer provides mechanical support for the elements of the gas sensor pixel. At certain locations, the dielectric layer from the bulk of the chip is connected to the dielectric layer in the pixels. This connections provides mechanical support and allows for electrical connections to the contact electrodes, heating element, and temperature sensor.

At step 350, a chemical sensing layer is formed on the contact electrodes. The chemical sensing material may be metal oxides such as oxides of chromium, manganese, nickel, copper, tin, indium, tungsten, titanium, vanadium, iron, germanium, niobium, molybdenum, tantalum, lanthanum, cerium, and neodymium. Alternatively, the chemical sensing materials may be composite oxides including binary, ternary, quaternary and complex metal oxides. Metal oxide gas sensors are low cost and have flexibility in production, are simple to use, and have a large number of detectable gases/possible application fields. Accordingly, the metal oxide used in a specific application may be selected for sensitivities to certain chemicals. Metal oxides also function well as a chemical sensing material because they can be used to detect chemical changes through conductivity change as well as by measuring the change of capacitance, work function, mass, optical characteristics or reaction energy. The chemical sensing layer may be formed through techniques such as printing, sputter deposition, CVD, or epitaxial growth. Deposition of the chemical sensing layer may include coating the pattern of electrodes with a metal oxide compound according to a defined arrangement. This deposition, or printing, of the chemical sensing material is advantageous because it avoids problems and costs with conventional lithography and masking and can be used to form the chemical sensing structures after the pixels are released from the substrate suspended above the isolation cavity.

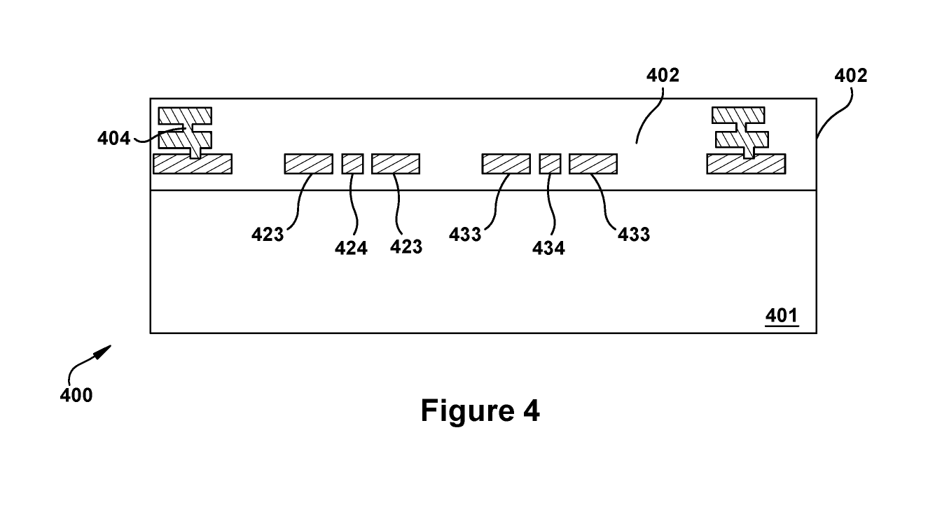

FIGS. 4-8 illustrate various stages of an example method for fabricating a chemical sensor in accordance with one or more embodiments of the disclosure. FIG. 4 shows a conventional CMOS wafer 400 with a dielectric layer 402 formed on a substrate 401. The substrate 401 can include, for example, a semiconductor layer (e.g., a silicon slab or a silicon-on-insulator layer). A heating element 423, 433 is embedded in the dielectric layer. The example embodiment in FIG. 4 shows two discrete heating elements, 423, 433 but this only illustrative. Actual devices may contain as many heating elements (and other elements described herein) as needed for the design. A temperature sensor 424, 434 is also embedded in the dielectric layer 402. The heating element 423, 433 can be formed through standard CMOS processes to for a resistive heating element, including using polysilicon, tungsten, titanium nitride, or silicon carbide. The temperature sensor 424, 434 may be formed from the same material and at the same time as the heating element 423, 433, thereby reducing processing time and complexity. The temperature sensor 424, 434 is made from a material whose physical properties—such as resistance—change as a function of temperature. Other devices required by the desired design may also be included. For example, one or more ASIC device 404 for controlling the heating, evaluating the pixel temperature, and/or determining the concentration of chemicals from the signals received from the pixels may be included.

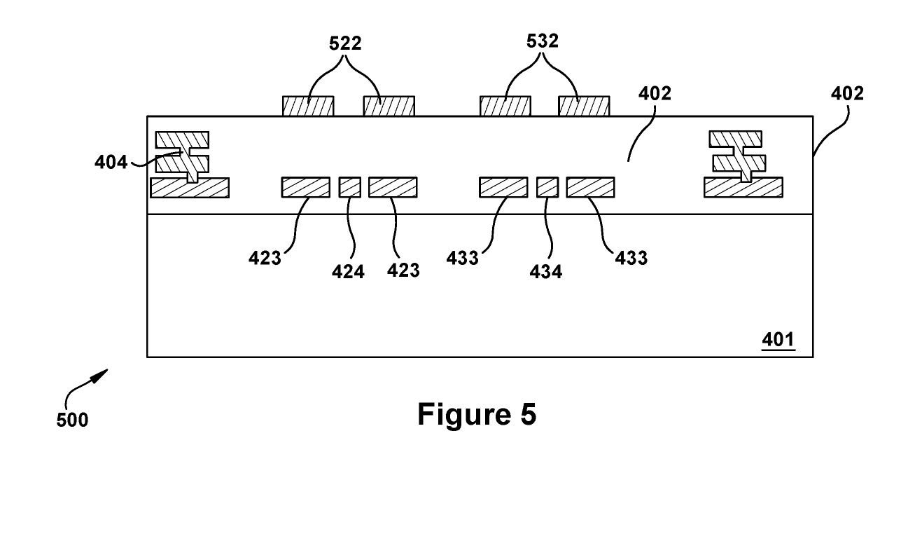

FIG. 5 shows a subsequent step in processing the wafer 400 from FIG. 4. In addition to the elements shown in FIG. 4, the wafer 500 in FIG. 5 has contact electrodes 522, 532 that are formed on the dielectric layer 402. The contact electrodes 522, 532 are made of conductive materials including, for example, noble metals or titanium nitride. The contact electrodes 522, 532 may be formed using conventional CMOS processing techniques including by sputter deposition followed by photolithographic patterning and removal of the unwanted deposited material.

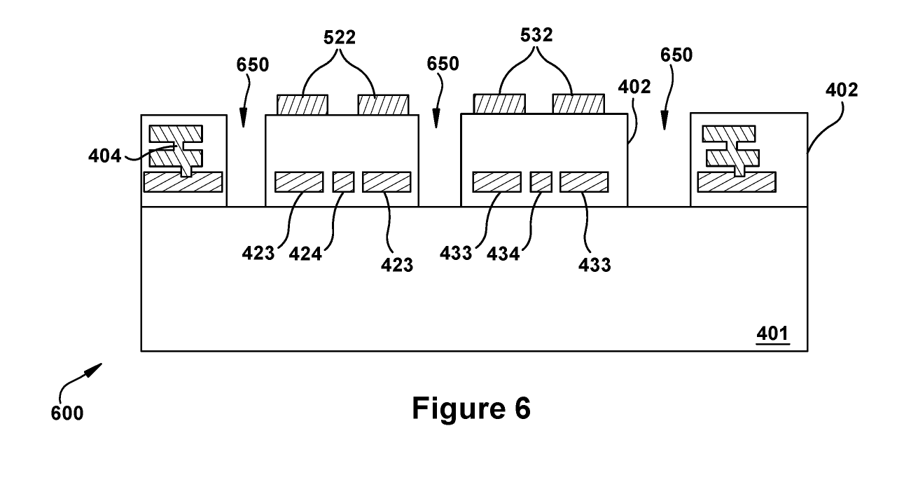

FIG. 6 shows a subsequent step in processing the wafer 500 from FIG. 5. In addition to the elements shown in FIG. 5, the wafer 600 in FIG. 6 has etched portions 650 in the dielectric layer. The etched portions 650 are etched to the substrate or layer underlying the dielectric layer 402. This etch may be done by wet etching or dry etching, and it can be isotropic or anisotropic. In a preferred method, as illustrated in FIG. 6, the etching is an anisotropic etch such as deep reactive ion etching.

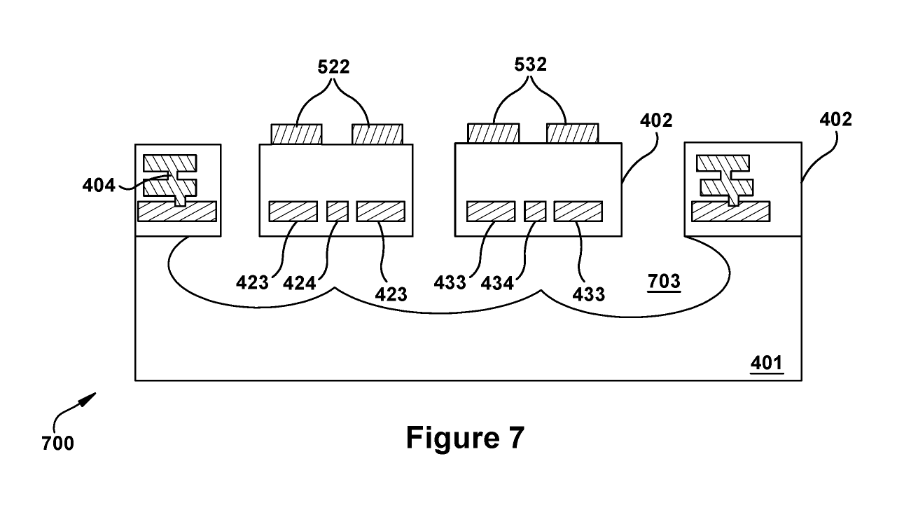

FIG. 7 shows a subsequent step in processing the wafer 600 from FIG. 6. In addition to the elements shown in FIG. 6, the wafer 700 in FIG. 7 illustrates the formation of an isolation cavity 703 in the substrate or area 401 underlying the dielectric layer 402. In the step shown in FIG. 7, the substrate or area 401 underlying the dielectric layer 402 is etched to release a portion of the dielectric layer 402 under the pixel area from the bulk of the substrate or underlying layer 401. This etch may be done by wet etching or dry etching, and it can be isotropic or anisotropic. In a preferred method, as shown in FIG. 7, the etching is an isotropic gas or plasma etch such as a xenon difluoride etch or a sulfur hexafluoride etch. In this etch step, a portion of the substrate or layer underneath the pixels is etched or otherwise removed to create a thermal isolation cavity 703 that thermally isolates the pixels from the bulk of the substrate. The thermal isolation cavity 703 allows integration of the chemical sensor with other devices (ASIC 404 for example) on the same chip. The thermal isolation cavity 703 protects other devices on the chip from heat produced by the heating element from possible thermal damage and reduces the power consumption required to heat the pixel to the operating temperature since less heat is dissipated from the pixel to the bulk substrate. The dielectric layer 402 provides mechanical support for the elements of the gas sensor pixel. At certain locations, the dielectric layer 402 from the bulk of the chip is connected to the dielectric layer 402 in the pixels. This connection provides mechanical support and allows for electrical connections to the contact electrodes, heating element, and temperature sensor.

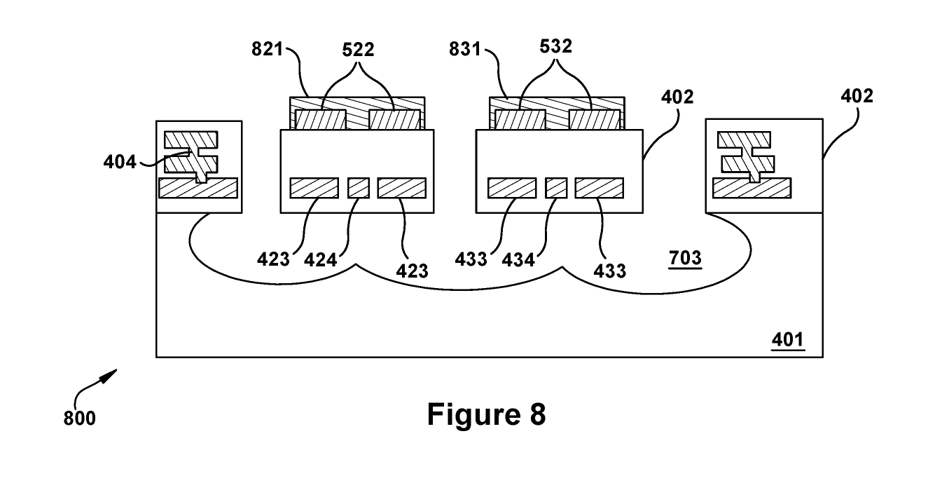

FIG. 8 shows a subsequent step in processing the wafer 700 from FIG. 7. In addition to the elements shown in FIG. 7, the wafer 800 in FIG. 8 illustrates the formation of a chemical sensing layer 821, 831 on the contact electrodes 522, 532. The chemical sensing material 821, 831 may be metal oxides such as oxides of chromium, manganese, nickel, copper, tin, indium, tungsten, titanium, vanadium, iron, germanium, niobium, molybdenum, tantalum, lanthanum, cerium, and neodymium. Alternatively, the chemical sensing materials 821, 831 may be composite oxides including binary, ternary, quaternary and complex metal oxides. Metal oxide gas sensors are low cost and have flexibility in production, are simple to use, and have a large number of detectable gases/possible application fields. Accordingly, the metal oxide used in a specific application may be selected for sensitivities to certain chemicals. Metal oxides also function well as a chemical sensing material because they can be used to detect chemical changes through conductivity change as well as by measuring the change of capacitance, work function, mass, optical characteristics or reaction energy. The chemical sensing layer may be formed through techniques such as printing, sputter deposition, CVD, or epitaxial growth. Printing the chemical sensing material may be advantageous because it avoids problems and costs with conventional lithography and masking and can be used to form the chemical sensing structures after the pixels are released from the substrate suspended above the isolation cavity. The contact electrodes 522, 532 are electrically connected to the chemical sensing material 821, 831 and are used to detect changes in the chemical sensing material as the concentration of the target gas changes.

As described above, one method for forming a gas sensor of the present invention includes providing a substrate 401, 402 comprising a semiconductor layer 401 and a dielectric layer 402 having embedded therein a heating structure 423, 433 and circuitry 404. The method also includes forming a pattern of electrodes 522, 532 on a surface of the dielectric layer 402, the pattern of electrodes 522, 532 overlays the heating structure 423, 433. The method further includes forming trenches 650 in the dielectric layer, wherein a first trench of the trenches separates the heating structure 423, 433 from the circuitry 404, and wherein a second trench of the trenches separates the heating structure 423 from another heating structure 433. Thereafter, the method includes releasing a portion of the dielectric layer 402 comprising the heating structure 423, 433 and the pattern of electrodes 522, 532 and forming a layer of a chemical sensing material 821, 831 overlying the pattern of electrodes 522, 532.

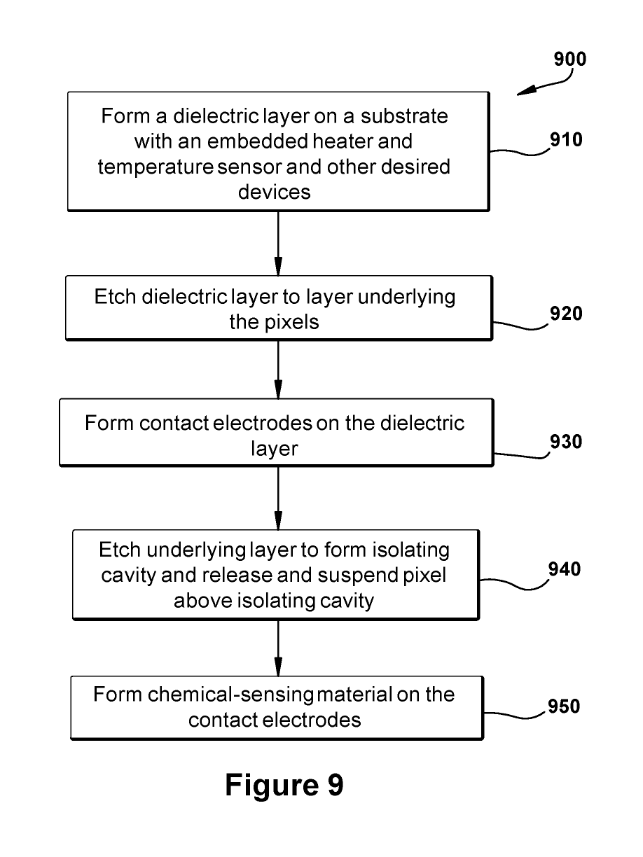

FIG. 9 presents a flowchart of another example method 900 for fabricating a gas sensor in accordance with one or more embodiments of the disclosure. At block 910, a dielectric layer is formed on a substrate. The substrate can include, for example, a semiconductor layer (e.g., a silicon slab or a silicon-on-insulator layer). A heating element is embedded in the dielectric layer. A temperature sensor is also embedded in the dielectric layer. The temperature sensor is used to measure the temperature of the pixel and provide feedback for temperature control. The heating element can be formed through standard CMOS processes to for a resistive heating element, including using polysilicon, tungsten, titanium nitride, or silicon carbide. The temperature sensor may be formed from the same material and at the same time as the heating element, thereby reducing processing time and complexity. The temperature sensor is made from a material whose physical properties—such as resistance—change as a function of temperature. Other devices required by the desired design may also be included. For example, one or more ASIC device for controlling the heating, evaluating the pixel temperature, and/or determining the concentration of chemicals from the signals received from the pixels may be included.

At block 920, the dielectric layer is etched to the substrate or layer underlying the pixels. This etch may be done by wet etching or dry etching and it can be isotropic or anisotropic. In a preferred method, the etching is an anisotropic etch such as a deep reactive ion etching. At block 930, contact electrodes are formed on the dielectric layer. The contact electrodes are electrically connected to the chemical sensing material and are used to detect changes in the chemical sensing material as the concentration of the target gas changes. The contact electrodes can be made of conductive materials including noble metals or titanium nitride. The contact electrodes may be formed using conventional CMOS processing techniques including by sputter deposition followed by photolithographic patterning and removal of the unwanted deposited material. As shown in the process illustrated in FIG. 9, the dielectric layer is etched prior to forming the contact electrodes on the dielectric layer. This sequence of steps may be preferred to make the process compatible with an etch tool to be used for the dielectric etch. For example, some tools may not allow etching with noble metals present or exposed. Indeed, many CMOS compatible tools do not allow noble metals like gold to be exposed during processing. Accordingly, the process shown in FIG. 9 allows for processing flexibility.

Next, at block 940, the substrate or area underlying the pixels is etched to release the pixels from the bulk of the substrate or underlying layer. This etch may be done by wet etching or dry etching and it can be isotropic or anisotropic. In a preferred method, the etching is an isotropic gas or plasma etch such as a xenon difluoride etch or a sulfur hexafluoride etch. In this etch step, a portion of the substrate or layer underneath the pixels is etched or otherwise removed to create a thermal isolation cavity that thermally isolates the pixels from the bulk of the substrate. The thermal isolation cavity allows integration of the chemical sensor with other devices (an ASIC for example) on the same chip. The thermal isolation cavity protects other devices on the chip from heat produced by the heating element. This protects the other devices from possible thermal damage and reduces the power consumption required to heat the pixel to the operating temperature since less heat is dissipated from the pixel to the bulk substrate. The dielectric layer provides mechanical support for the elements of the gas sensor pixel. At certain locations, the dielectric layer from the bulk of the chip is connected to the dielectric layer in the pixels. This connections provides mechanical support and allows for electrical connections to the contact electrodes, heating element, and temperature sensor.

At step 950, a chemical sensing layer is formed on the contact electrodes. The chemical sensing material may be metal oxides such as oxides of chromium, manganese, nickel, copper, tin, indium, tungsten, titanium, vanadium, iron, germanium, niobium, molybdenum, tantalum, lanthanum, cerium, and neodymium. Alternatively, the chemical sensing materials may be composite oxides including binary, ternary, quaternary and complex metal oxides. Metal oxide gas sensors are low cost and have flexibility in production, are simple to use, and have a large number of detectable gases/possible application fields. Accordingly, the metal oxide used in a specific application may be selected for sensitivities to certain chemicals. Metal oxides also function well as a chemical sensing material because they can be used to detect chemical changes through conductivity change as well as by measuring the change of capacitance, work function, mass, optical characteristics or reaction energy. The chemical sensing layer may be formed through techniques such as printing, sputter deposition, CVD, or epitaxial growth. Printing the chemical sensing material may be advantageous because it avoids problems and costs with conventional lithography and masking and can be used to form the chemical sensing structures after the pixels are released from the substrate suspended above the isolation cavity.

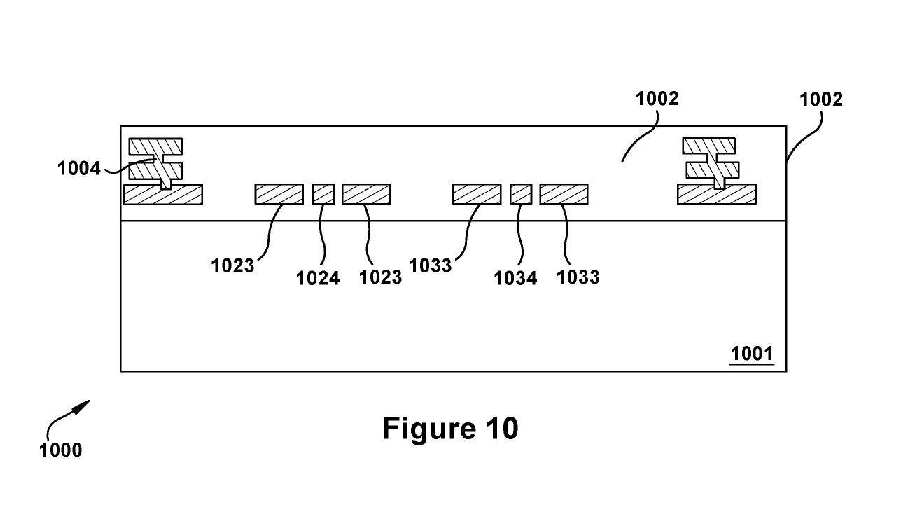

FIGS. 10-14 illustrate various stages of an example method for fabricating a chemical sensor in accordance with one or more embodiments of the disclosure. FIG. 10 shows a conventional CMOS wafer 1000 with a dielectric layer 1002 formed on a substrate 1001. The substrate 1001 can include, for example, a semiconductor layer (e.g., a silicon slab or a silicon-on-insulator layer). A heating element 1023, 1033 is embedded in the dielectric layer. The example embodiment in FIG. 10 shows two discrete heating elements, 1023, 1033 but this only illustrative. Actual devices may contain as many heating elements (and other elements described herein) as needed for the design. A temperature sensor 1024, 1034 is also embedded in the dielectric layer 1002. The heating element 1023, 1033 can be formed through standard CMOS processes to for a resistive heating element, including using polysilicon, tungsten, titanium nitride, or silicon carbide. The temperature sensor 1024, 1034 may be formed from the same material and at the same time as the heating element 1023, 1033, thereby reducing processing time and complexity. The temperature sensor 1024, 1034 is made from a material whose physical properties—such as resistance—change as a function of temperature. Other devices required by the desired design may also be included. For example, one or more ASIC device 1004 for controlling the heating, evaluating the pixel temperature, and/or determining the concentration of chemicals from the signals received from the pixels may be included.

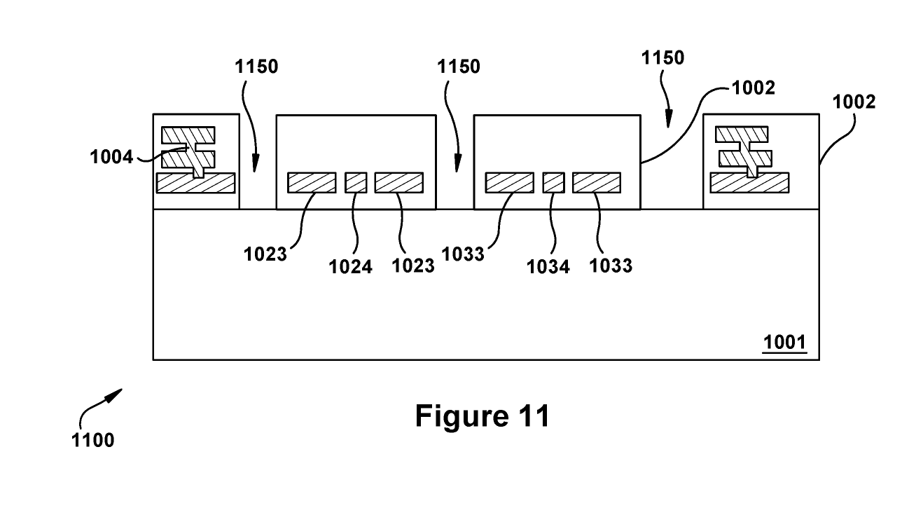

FIG. 11 shows a subsequent step in processing the wafer 1000 from FIG. 10. In addition to the elements shown in FIG. 10, the wafer 1100 in FIG. 11 has etched portions 1150 in the dielectric layer. The etched portions 1150 are etched to the substrate or layer underlying the dielectric layer 1002. This etch may be done by wet etching or dry etching and it can be isotropic or anisotropic. In a preferred method, as illustrated in FIG. 11, the etching is an anisotropic etch such as deep reactive ion etching.

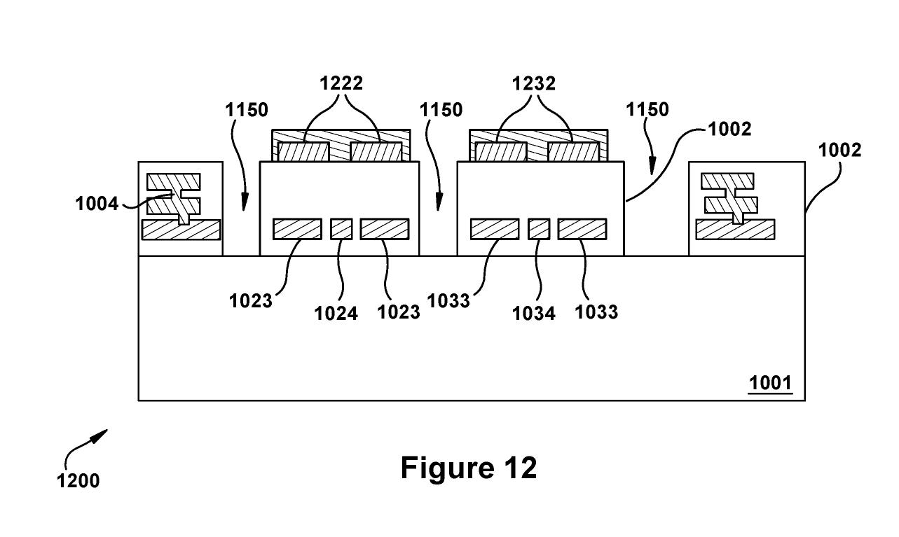

FIG. 12 shows a subsequent step in processing the wafer 1100 from FIG. 11. In addition to the elements shown in FIG. 11, the wafer 1200 in FIG. 12 has contact electrodes 1222, 1232 that are formed on the dielectric layer 1002. The contact electrodes 1222, 1232 are made of conductive materials including, for example, noble metals or titanium nitride. The contact electrodes 1222, 1232 may be formed using conventional CMOS processing techniques including by sputter deposition followed by photolithographic patterning and removal of the unwanted deposited material.

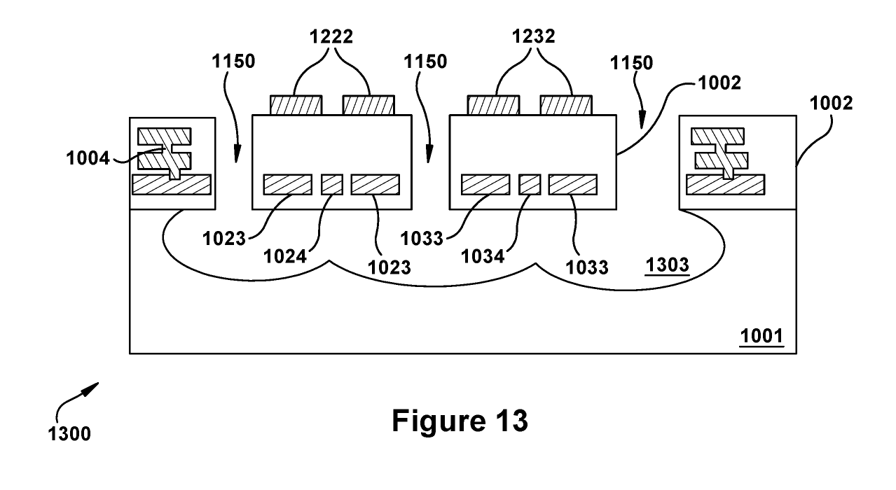

FIG. 13 shows a subsequent step in processing the wafer 1200 from FIG. 12. In addition to the elements shown in FIG. 12, the wafer 1300 in FIG. 13 illustrates the formation of an isolation cavity 1303 in the substrate or area 1001 underlying the dielectric layer 1002. In the step shown in FIG. 13, the substrate or area 1001 underlying the dielectric layer 1002 is etched to release a portion of the dielectric layer 1002 under the pixel area from the bulk of the substrate or underlying layer 1001. This etch may be done by wet etching or dry etching and it can be isotropic or anisotropic. In a preferred method, as shown in FIG. 13, the etching is an isotropic gas or plasma etch such as a xenon difluoride etch or a sulfur hexafluoride etch. In this etch step, a portion of the substrate or layer underneath the pixels is etched or otherwise removed to create a thermal isolation cavity 1303 that thermally isolates the pixels from the bulk of the substrate. The thermal isolation cavity 1303 allows integration of the chemical sensor with other devices (ASIC 404 for example) on the same chip. The thermal isolation cavity 1303 protects other devices on the chip from heat produced by the heating element from possible thermal damage and reduces the power consumption required to heat the pixel to the operating temperature since less heat is dissipated from the pixel to the bulk substrate. The dielectric layer 1002 provides mechanical support for the elements of the gas sensor pixel. At certain locations, the dielectric layer 1002 from the bulk of the chip is connected to the dielectric layer 1002 in the pixels. This connection provides mechanical support and allows for electrical connections to the contact electrodes, heating element, and temperature sensor.

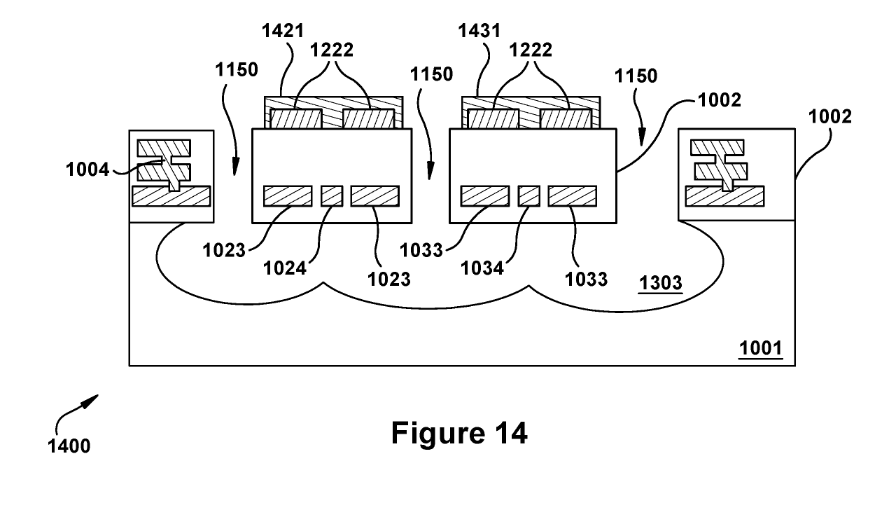

FIG. 14 shows a subsequent step in processing the wafer 1300 from FIG. 13. In addition to the elements shown in FIG. 13, the wafer 1400 in FIG. 14 illustrates the formation of a chemical sensing layer 1421, 1431 on the contact electrodes 1222, 1232. The chemical sensing material 1421, 1431 may be metal oxides such as oxides of chromium, manganese, nickel, copper, tin, indium, tungsten, titanium, vanadium, iron, germanium, niobium, molybdenum, tantalum, lanthanum, cerium, and neodymium. Alternatively, the chemical sensing materials 1421, 1431 may be composite oxides including binary, ternary, quaternary and complex metal oxides. Metal oxide gas sensors are low cost and have flexibility in production, are simple to use, and have a large number of detectable gases/possible application fields. Accordingly, the metal oxide used in a specific application may be selected for sensitivities to certain chemicals. Metal oxides also function well as a chemical sensing material because they can be used to detect chemical changes through conductivity change as well as by measuring the change of capacitance, work function, mass, optical characteristics or reaction energy. The chemical sensing layer may be formed through techniques such as printing, sputter deposition, CVD, or epitaxial growth. Printing the chemical sensing material may be advantageous because it avoids problems and costs with conventional lithography and masking and can be used to form the chemical sensing structures after the pixels are released from the substrate suspended above the isolation cavity. The contact electrodes 1222, 1232 are electrically connected to the chemical sensing material 1421, 1431 and are used to detect changes in the chemical sensing material as the concentration of the target gas changes.

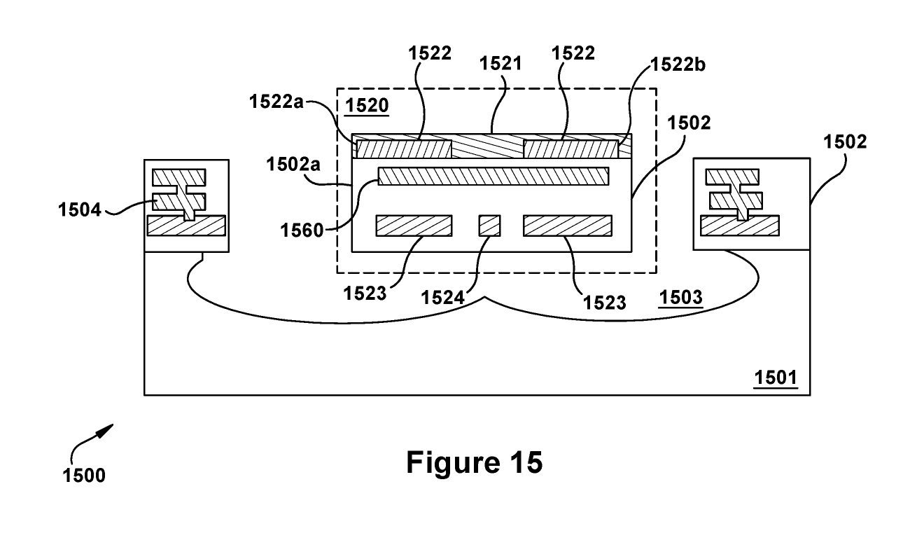

FIG. 15 illustrates an alternative embodiment of the chemical sensor 1500 of the present invention. The chemical sensor 1500 in FIG. 15 includes the elements previously described with respect to the chemical sensor 100 shown in FIG. 1 and FIG. 2. The chemical sensor 1500 includes a substrate 1501 on which the other elements are built. On the substrate 1501, a dielectric layer 1502 is deposited or formed. For illustration, the gas sensor 1500 includes one sensor pixel 1520. The gas sensor 1500 can be built with many pixels of one or more types of pixel. Having multiple types of sensor pixel allows the sensor to use various receptors that are sensitive to different types and concentrations of gases and thereby detect and distinguish between different gases and concentrations.

Pixel 1520 includes a layer of chemical sensing materials 1521. The chemical sensing material may be metal oxides including oxides of chromium, manganese, nickel, copper, tin, indium, tungsten, titanium, vanadium, iron, germanium, niobium, molybdenum, tantalum, lanthanum, cerium, and neodymium. Alternatively, the chemical sensing materials may be composite oxides including binary, ternary, quaternary and complex metal oxides. Metal oxide gas sensors are low cost and have flexibility in production, are simple to use, and have a large number of detectable gases/possible application fields. Accordingly, the metal oxide used in a specific application may be selected for sensitivities to certain chemicals. Metal oxides also function well as a chemical sensing material because they can be used to detect chemical changes through conductivity change as well as by measuring the change of capacitance, work function, mass, optical characteristics or reaction energy.

Adjacent to the chemical sensing material 1521, there are contact electrodes 1522. The contact electrodes 1522 are electrically connected to the chemical sensing material 1521 and are used to detect changes in the chemical sensing material 1521 as the concentration of the target gas changes. The contact electrodes 1522 can be made of conductive materials including noble metals or titanium nitride.

The gas sensor pixels 1521 also includes a heating element 1523. The heating element can be formed through standard CMOS processes to for a resistive heating element, including using polysilicon, tungsten, titanium nitride, or silicon carbide. In on embodiment of the gas sensor, the heating element is formed to maximize the surface area per unit of area to improve heating efficiency. The heating element 1523 is beneficial to the gas sensing pixel because the chemical sensing materials 1523 may only be sensitive at a high temperatures. Moreover, different chemical sensing materials may have different activation temperatures, and the heating element can be used to optimize conditions for a given gas. The gas sensor pixels 1521 also include a temperature sensor 1524 to measure the temperature of the pixels 1521 and provide feedback for temperature control. The temperature sensor 1524 may be formed from the same material and at the same time as the heating element 1523 thereby reducing processing time and complexity. The temperature sensor 1524 may be formed from a material whose resistance changes as a function of temperature.

As shown in FIG. 15, the dielectric layer 1502 is adjacent to the chemical sensing material 1521, contact electrodes 1522, heating element 1523, and temperature sensor 1524. The dielectric layer 1502 provides thermal coupling between the heating element 1523 and the chemical sensing material 1521 so that the heat provided by the heating element 1523 is conducted to the chemical sensing material 1521. Accordingly, the dielectric is preferably a low k dielectric material with high thermal conductivity. The dielectric layer 1502 also provides mechanical support for the elements of the gas sensor pixel 1520. At locations not shown in FIG. 15, the dielectric layer 1502 from the bulk of the chip is connected to the dielectric layer 1502 in the pixel 1520. This connection provides mechanical support and allows for electrical connections to the contact electrodes 1522, heating element 1523, and temperature sensor 1524. A portion of the substrate 1501 underneath the pixels 1520 is etched or otherwise removed to create a thermal isolation cavity 1503 that thermally isolates the pixel 1520 from the bulk of the substrate. The thermal isolation cavity 1503 allows integration of the chemical sensor with other devices (ASIC 1504 for example) on the same chip. The thermal isolation cavity 1503 protects other devices on the chip from heat produced by the heating element 1523. This protects the other devices from possible thermal damage and reduces the power consumption required to heat the pixel 1520 to the operating temperature since less heat is dissipated from the pixel 1520 to the bulk substrate.

In addition to the elements previously described with respect to the chemical sensor 100 shown in FIG. 1 and FIG. 2, the chemical sensor 1500 includes a gate electrode 1560 in the dielectric layer 1502. In this arrangement, the electrodes 1522 may serve as a source and drain of a thin film transistor formed in combination with the gate electrode 1560. As shown in FIG. 15, there is a layer of dielectric separating the source and drain electrodes 1522 from the gate electrode 1560. This configuration allows physical properties of the channel—the area of the chemical sensing material 1521 between the two electrodes 1522—to be modified by changing the voltage applied at the gate electrode 1560. In this design, the gate voltage can be used to tune the sensitivity of the sensing material 1522. In order to characterize the response of the sensing material 1522, the transconductance, mobility of the sensing material, the threshold voltage, leakage current, and/or resistance of the channel can be measured. The following equations demonstrate the relationship between drain current ID and gate voltage V_{G} and between the gate-semiconductor work function change ΔΨ_{MS} and change in threshold voltage ΔV_{T}. In the equations below, μ is the carrier mobility, Cᵢ is the insulator capacitance, W_{eff} is the effective channel dimension of the transistor, L_{eff} is the effective inductance of the transistor, V_{D} is the drain voltage and V_{T} is the threshold voltage of the transistor.

$${I}_{D} = μ {C}_{i} \frac{{W}_{eff}}{{L}_{eff}} ( {V}_{G} - {V}_{T} ) {V}_{D}$$

$$Δ {Ψ}_{MS} = Δ {V}_{T}$$

The change in the drain current ID can be easily measured by a subsequent amplifying circuit, which may be included in the ASIC 1504 for example. The measurement circuit can be based on a current, voltage or RC impedance measurement. In this design, the gate voltage can be used to tune the sensitivity of the gas sensor. In one example, the ASIC 1504 is electrically coupled to the gate electrode 1560 and configured to supply an electric signal based on a defined adjustment of the response of the layer of the chemical sensing material 1521 to the concentration of gas in the environment around the chemical sensing material 1521. The transistor architecture in these examples has advantages over other chemical sensors because it is more scalable and sensitive due to the amplifying effect.

The gate electrode 1560 may be formed using conventional CMOS processing technology. For example, the gate electrode 1560 may be formed using aluminum. And the gate electrode 1560 may be formed simultaneously with another layer of a device (for example ASIC 1504) formed on the substrate 1501. The chemical sensor 1500 may be formed by the processes illustrated in FIGS. 3-14.

In an exemplary embodiment, the gas sensor 1500 includes a heating element 1523 embedded in a suspended dielectric layer 1502a. The gas sensor 1500 also has a first electrode 1522a on a surface of the suspended dielectric layer 1502a and a second electrode 1522b on the surface of the suspended dielectric layer 1502a. In this example, the first electrode 1522a and the second electrode 1522b are arranged to form an elongated channel. The elongated channel is shown as the space between the first electrode 1522a and the second electrode 1522b in FIG. 15. A layer of a chemical sensing material 1521 is thermally coupled to the heating element 1523 and exposed to an environment and the layer of the chemical sensing material 1521 overlays the first electrode 1522a and the second electrode 1522b and fills the elongated channel. In this example, the chemical sensing material 1521 has an electrical resistance responsive to a concentration of gas in the environment and the operating temperature of the chemical sensing material 1521. The gas sensor 1500 also includes a third electrode 1560 embedded in the suspended dielectric layer 1502a and configured to adjust a response of the layer of the chemical sensing material 1521 to the concentration of gas.

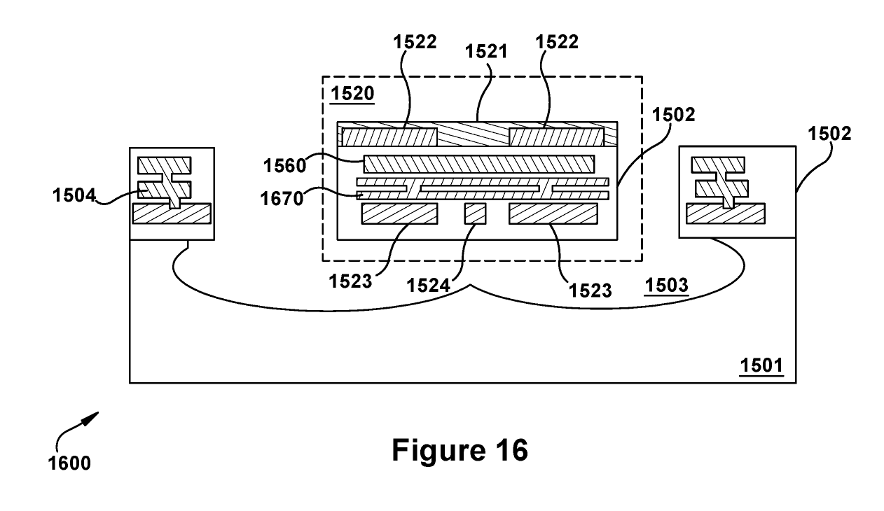

FIG. 16 illustrates an alternative embodiment of the chemical sensor 1600 of the present invention. The chemical sensor 1600 in FIG. 16 includes the elements previously described with respect to the chemical sensor 1500 shown in FIG. 15 and also includes one or more layer 1670 for heat distribution. The heat distribution layer 1670 causes the heat from the heating element 1523 be more evenly distributed to the other portions of the pixel 1520 including the chemically sensitive layer 1521. The heat distribution layer 1670 may be a metal layer formed through standard CMOS processing. A heat distribution may be incorporated in any of the designs or process discussed in this application. The chemical sensor 1600 may be formed by the processes illustrated in FIGS. 3-14.

It should be appreciated that the present disclosure is not limited with respect to the chemical sensors illustrated in the figures. Rather, discussion of a specific chemical sensors for merely for illustrative purposes.

In the present specification, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should generally be construed to mean “one or more” unless specified otherwise or clear from context to be directed to a singular form.

In addition, the terms “example” and “such as” are utilized herein to mean serving as an instance or illustration. Any embodiment or design described herein as an “example” or referred to in connection with a “such as” clause is not necessarily to be construed as preferred or advantageous over other embodiments or designs. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time.

What has been described above includes examples of one or more embodiments of the disclosure. It is, of course, not possible to describe every conceivable combination of components or methodologies for purposes of describing these examples, and it can be recognized that many further combinations and permutations of the present embodiments are possible. Accordingly, the embodiments disclosed and/or claimed herein are intended to embrace all such alterations, modifications and variations that fall within the spirit and scope of the detailed description and the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
a heating element embedded in a suspended dielectric layer;
a first electrode on a surface of the suspended dielectric layer;
a second electrode on the surface of the suspended dielectric layer, wherein the first electrode and the second electrode are arranged to form an elongated channel;
a layer of a chemical sensing material thermally coupled to the heating element and exposed to an environment, wherein the layer of the chemical sensing material overlays the first electrode and the second electrode and fills the elongated channel, and wherein the chemical sensing material has an electrical resistance responsive to a concentration of gas in the environment and a temperature of the chemical sensing material; and
a third electrode embedded in the suspended dielectric layer and configured to adjust a response of the layer of the chemical sensing material to the concentration of gas.

2. The device of claim 1, further comprising a metal structure embedded in the suspended dielectric layer, the metal structure is disposed between the heating element and the third electrode.

3. The device of claim 1, wherein the chemical sensing material comprises a metal oxide compound.

4. The device of claim 1, further comprising a temperature sensor configured to supply an electric signal in response to the temperature of the chemical sensor, wherein the temperature sensor comprises polycrystalline silicon.

5. The device of claim Error! Reference source not found., further comprising a structure that is mechanically coupled to the semiconductor substrate and has integrated circuitry configured to control a temperature of the layer of the chemical sensing material.

6. The device of claim 5, wherein the integrated circuitry is further configured to measure the electrical resistance of the layer of the chemical sensing material.

7. The device of claim 5, wherein the integrated circuitry is electrically coupled to the third electrode and configured to supply an electric signal based on a defined adjustment of the response of the layer of the chemical sensing material to the concentration of gas.

8. The device of claim 1, wherein the heating element is formed from an electrically conductive material selected from the group consisting of polycrystalline silicon, tungsten, and titanium nitride, silicon carbide.

9. The device of claim 1, wherein the first electrode and the second electrode are formed from a noble metal, and wherein the third electrode comprises aluminum.

10. The device of claim 1, wherein a dielectric layer is disposed between the third electrode and the chemical sensing material.

11. The device of claim 1, wherein an electrical potential is applied between first, second and third electrode.

12. The device of claim 1, wherein the first electrode, second electrode, third electrode, chemical sensing material, and the dielectric layer are configured to form a thin film transistor.
